(19) United States
(12) Patent Application Publication
(10) Pub. No.: US 2022/0147394 A1
(43) Pub. Date: May 12, 2022

(54) CONCEPT FOR DATA PROCESSING FOR AN AT LEAST PARTIALLY AUTOMATED GUIDANCE OF A MOTOR VEHICLE

(71) Applicant: Robert Bosch GmbH, Stuttgart (DE)

(72) Inventors: Andreas Lehn, Ludwigsburg (DE); Christopher Murphy, Talheim (DE); Gerrit Quast, Nuertingen (DE); Matthew Nimmo, Ludwigsburg (DE); Stefan Nordbruch, Leonberg (DE); Stefan Schaupp, Gerlingen (DE); Rolf Nicodemus, Bietigheim-Bissingen (DE)

(21) Appl. No.: 17/434,828

(22) PCT Filed: Apr. 9, 2020
(86) PCT No.: PCT/EP2020/060139

§ 371 Date: Aug. 30, 2021

(30) Foreign Application Priority Data
May 20, 2019 (DE) 10 2019 207 342.5

(51) Int. Cl. G06F 9/50; B60W 50/06; B60W 50/02

(52) U.S. Cl. CPC G06F 9/5027; B60W 50/06; B60W 50/0205; B60W 2552/00; B60W 2050/0215; B60W 2555/20; B60W 2556/45; B60W 2556/50; B60W 2554/406

(57) ABSTRACT

A method for determining a demand for processing resources for carrying out processing of data for at least partly automated guidance of a motor vehicle. Provision is made to adapt available processing resources for carrying out data processing to a determined demand for processing resources. An apparatus, a computer system, a computer program, and a machine-readable storage medium are also described.

### FIELD

The present invention relates to a method for determining a demand for processing resources for carrying out processing of data for at least partly automated guidance of a motor vehicle. The present invention further relates to an apparatus, to a computer system, to a computer program, and to a machine-readable storage medium.

### BACKGROUND INFORMATION

A parking environment can be monitored, for instance, by infrastructure sensors, for example cameras or lidar sensors.

The sensors transmit their sensor data, as a rule via one or several cables, to a central computer system that evaluates the sensor data.

Planning functions for at least partly automated control of motor vehicles within the parking environment can be carried out, for instance, in the computer system itself.

The computer system is usually made up of a static network or system that is dimensioned once before the parking facility is put into service.

A computer system of this kind must, as a rule, carry out many parallel calculations.

This usually means that the computer system requires high computing performance and a great deal of memory.

This results, for instance, in high costs, in particular also as a result of additional special hardware in the computer system.

In addition, long latency times can occur as a result of the wire-based transfer of the sensor data from the sensors to the computer system.

Power consumption can also be elevated.

### SUMMARY

An object of the present invention is that of efficiently determining a demand for processing resources for carrying out processing of data for at least partly automated guidance of a motor vehicle.

This object may be achieved by way of example embodiment of the present invention. Advantageous embodiments of the present invention are described herein.

According to a first aspect of the present invention, a method for determining a demand for processing resources for carrying out processing of data for at least partly automated guidance of a motor vehicle is furnished. In accordance with an example embodiment of the present invention, the method includes the following steps:
receiving parameter signals that represent at least one parameter influencing processing resources for carrying out processing of data for at least partly automated guidance of a motor vehicle;
receiving processing resource signals that represent available processing resources for carrying out processing of data for at least partly automated guidance of a motor vehicle;
determining a demand for required processing resources for carrying out processing of data for at least partly automated guidance of a motor vehicle, based on the at least one parameter and based on the available processing resources;
outputting demand signals, which represent the determined demand and/or a discrepancy between the determined demand and the available processing resources, if the available processing resources for carrying out processing of data for at least partly automated guidance of a motor vehicle are not sufficient to allow the available processing resources to be adapted based on the determined demand and/or on the discrepancy.

According to a second aspect of the present invention, an apparatus that is configured to execute all steps of the method(s) in accordance with the first aspect is furnished.

According to a third aspect of the present invention, a computer system, which encompasses a computer network that has several networked computers and in particular is part of a cloud infrastructure, and encompasses the apparatus according to the second aspect, is furnished.

According to a fourth aspect of the present invention, a computer program that encompasses instructions which, upon execution of the computer program by a computer, for example by the apparatus in accordance with the second aspect, cause the latter to execute a method (methods) in accordance with the first aspect, is furnished.

According to a fifth aspect of the present invention, a machine-readable storage medium, on which the computer program according to the fourth aspect is stored, is furnished.

An example embodiment of the present invention is based on, and includes, the recognition that the above object can be achieved by the fact that in the context of data processing for at least partly automated guidance of a motor vehicle, the available processing resources can be checked as to whether or not they are still sufficient for processing of the data. Parameters that can have an influence on the available processing resources are, in particular, used for this check.

If a demand exists because the available processing resources are not sufficient, demand signals that represent the determined demand, and/or a discrepancy between the determined demand and the available processing resources, are correspondingly outputted so that the available processing resources can be adapted based on the determined demand and/or on the discrepancy.

The available processing resources are thus dynamically scaled, i.e., dynamically adapted, in particular based on the determined demand and/or on the discrepancy.

This advantageously ensures that sufficient processing resources for processing data for at least partly automated guidance of a motor vehicle are always available.

A technical advantage produced is thus, in particular, that the data for at least partly automated guidance of a motor vehicle can be processed efficiently.

Example embodiments of the present invention furthermore have an advantage, in particular, that different situations that can occur in the context of at least partly automated guidance of a motor vehicle can be addressed efficiently.

A further technical advantage thereby produced is, in particular, that only the exact processing resources that are in fact required need to be furnished.

For instance, if the determined demand is greater than the available processing resources, in accordance with an embodiment provision is made that the available processing resources are increased.

For instance, if the determined demand is less than the available processing resources, in accordance with an embodiment provision is made that the available processing resources are reduced.

The available processing resources are thereby, in particular, advantageously used efficiently.

Because the demand for processing resources is determined based on at least one parameter influencing the processing resources for carrying out processing of data for at least partly automated guidance of a motor vehicle, a further technical advantage produced is in particular that the demand for processing resources can be determined efficiently.

The term “at least one parameter” encompasses in particular the term “one or several parameters.”

In a context of several parameters they are, for example, the same or, for example, different.

According to an example embodiment, provision is made that the at least one parameter is a respective element selected from the following group of parameters: size of an infrastructure within which motor vehicles are being and/or are to be at least partly automatedly guided; number of motor vehicles currently being at least partly automatedly guided within the infrastructure; number of other traffic participants, other than at least partly automatedly guided motor vehicles, which are currently present within the infrastructure; environmental parameters of the infrastructure, in particular weather data, light data, visibility data, motor-vehicle-internal processing resources, infrastructure-internal processing resources, in particular performance parameters of a surroundings sensor of the infrastructure; processing resources of a computer and/or of a computer network; current reliability requirement with regard to reliable at least partly automated guidance of a motor vehicle; current reliability requirement with regard to reliable processing of the data, a current reliability requirement indicating in particular a number of redundant processing steps (calculations) utilizing the data.

The technical advantage thereby produced is, for instance, that particularly suitable parameters can be used.

The number of redundant processing steps thus indicates, in particular, how many and, in particular, which of the steps of the method are to be carried out redundantly.

A size of an infrastructure encompasses, for instance, an area of the infrastructure.

A size of an infrastructure encompasses, for instance, an indication as to whether specific regions of the infrastructure, for instance a level of a parking facility, are currently or in the future not used for at least partly automated guidance of a motor vehicle. If the infrastructure encompasses, for instance, a parking facility, the indication can encompass the fact that a specific level of the parking facility is currently not being utilized.

Motor-vehicle-internal processing resources are furnished, for instance, by motor-vehicle-internal computers and/or control units.

Infrastructure-internal processing resources are furnished, for instance, by an infrastructure surroundings sensor.

A performance parameter of a surroundings sensor of the infrastructure indicates, for instance, the computing performance, or generally the processing resources, that the surroundings sensor can furnish for the processing of data.

A “computer or computer network” in “processing resources of a computer and/or of a computer network” refers to computers or a computer network that process/processes data for at least partly automated guidance of a motor vehicle.

The computer or the computer network is, for instance, the computer or computer network of the computer system according to the third aspect.

In accordance with an example embodiment of the present invention, provision is made that the determination of the demand encompasses a determination of a demand time that indicates how long the determined demand will be required, the demand signals additionally representing the determined demand time.

The technical advantage thereby produced is, for instance, that efficient planning in terms of furnishing the available processing resources can be carried out.

In accordance with an example embodiment of the present invention, provision is made that the determination of the demand encompasses a determination of a functional demand for processing resources for a predetermined function that is to be performed for at least partly automated guidance of a motor vehicle, the demand signals additionally representing the determined functional demand.

A technical advantage thereby produced is, for instance, that sufficient processing resources for a predetermined function can be furnished.

A predetermined function is, for instance, one of the following functions: path planning for an at least partly automatedly guided motor vehicle; analysis of surroundings of a motor vehicle based on surroundings data of one or several surroundings sensors; and/or remote control of one or several motor vehicles.

When “function” is in the singular, the plural is always to be understood, and vice versa.

According to an example embodiment of the present invention, provision is made that in reaction to the outputting of the demand signals, the available processing resources are adapted based on the determined demand and/or on the discrepancy.

A technical advantage thereby produced is that, for instance, the available processing resources are efficiently adapted.

An “adaptation” for purposes of the description encompasses an increase and/or a decrease.

Depending on the specific processing resource it can be, for instance, increased or decreased.

For instance, one processing resource can be increased and another processing resource can be decreased.

For example, a bandwidth can be increased if the available bandwidth is not sufficient. For example, reserved memory can be at least partly released, i.e., decreased, if memory corresponding to the reserved memory is not required. For example, a number of processors can be increased if the number of processors is not sufficient to carry out processing of the data, for example, in a predetermined minimum time. Processors can, for instance, be combined into units that each perform a predetermined function for at least partly automated guidance of a motor vehicle.

Those units can, for instance, operate in parallel.

A predetermined function is, for instance, path planning, analysis of the surroundings data, or generation of remote-control instructions for remote control of a motor vehicle.

A “unit” for purposes of the description constitutes, in particular, an assemblage made up of one or several computers that each encompass one or several processors.

A “computer” for purposes of the description encompasses one or several processors.

A “computing device' for purposes of the description can also be referred to as a “computer.” The terms “computing device” and “computer” are used synonymously.

The decreasing and/or increasing of a memory capacity encompasses, for instance, reserving (increasing) memory space or releasing (decreasing) reserved memory space.

According to an example embodiment of the present invention, provision is made that the data respectively encompass one or several elements of the following group of data: sensor data of a surroundings sensor; weather data; navigation data; position data; control data for controlling transverse and/or longitudinal guidance of the motor vehicle; traffic data; result data of a result of a calculation for at least partly automated guidance of the motor vehicle; diagnostic data of a sensor of the motor vehicle.

A technical advantage thereby produced is, for instance, that particularly suitable data are processed.

According to an example embodiment of the present invention, provision is made that the apparatus according to the second aspect is encompassed by the computer network of the computer system in accordance with the fourth aspect.

According to an example embodiment of the present invention, provision is made that the apparatus according to the second aspect is not encompassed by the computer network of the computer system according to the third aspect.

Provision is made, for instance, that the apparatus according to the second aspect is encompassed by the infrastructure.

The computer network is, for instance, part of a cloud infrastructure.

In accordance with an example embodiment of the present invention, the apparatus according to the second aspect is one of the networked computers of the computer network of the computer system according to the third aspect.

Data for at least partly automated guidance of a motor vehicle are suitable for use for at least partly automated guidance of a motor vehicle.

This therefore means that the data are suitable for use in the context of at least partly automated guidance of a motor vehicle.

According to an example embodiment of the present invention, provision is made that the data respectively encompass one or several elements of the following group of data: sensor data of a surroundings sensor; weather data; navigation data; position data; control data for controlling transverse and/or longitudinal guidance of the motor vehicle; traffic data; result data of a result of a calculation for at least partly automated guidance of the motor vehicle; diagnostic data of a sensor of the motor vehicle.

A technical advantage thereby produced is, for instance, that particularly suitable data are used for at least partly automated guidance of the motor vehicle.

Sensor data represent, for instance, surroundings of the motor vehicle.

In accordance with an example embodiment of the present invention, a surroundings sensor is one of the following surroundings sensors: radar sensor, lidar sensor, ultrasonic sensor, magnetic field sensor, infrared sensor, and video sensor.

In accordance with an example embodiment of the present invention, a surroundings sensor is a surroundings sensor of the motor vehicle.

In accordance with an example embodiment of the present invention, a surroundings sensor is a surroundings sensor of an infrastructure in which the motor vehicle is to be and/or is being at least partly automatically guided.

The infrastructure is encompassed, for instance, by a parking facility.

For instance, the at least partly automated guidance encompasses at least partly automated entry into and/or exit from a parking space by the motor vehicle.

In accordance with an example embodiment of the present invention, the sensor of the motor vehicle is a surroundings sensor.

In accordance with an example embodiment of the present invention, several surroundings sensors, which for example are the same or different, are provided.

In accordance with an example embodiment of the present invention, a sensor of the motor vehicle is one of the following sensors: surroundings sensor, airbag sensor, tire pressure sensor, oil temperature sensor.

Weather data represent, for instance, weather in the surroundings of the motor vehicle.

Navigation data represent, for instance, an intended route of the motor vehicle.

Position data represent, for instance, an instantaneous position of the motor vehicle.

Position data represent, for instance, an instantaneous position of one or several further motor vehicles in the surroundings of the motor vehicle.

Control data represent, for instance, control instructions for a motor vehicle control device that is configured to control transverse and/or longitudinal guidance of the motor vehicle in at least partly automated fashion based on the control instructions.

According to an example embodiment of the present invention, the processing resources encompass: computer performance; memory capacity; data transfer rate and/or bandwidth available for data transfer via a communication network. Communication with the computer network can occur, for instance, via the communication network.

When “motor vehicle” is in the singular, the plural is always also to be understood, and vice versa.

According to an example embodiment of the present invention, the method according to the first aspect is a computer-implemented method.

According to an example embodiment of the present invention, provision is made that the method in accordance with the first aspect is executed or carried out by way of the apparatus in accordance with the second aspect.

Apparatus feature are evident analogously from method features, and vice versa.

This therefore means, in particular, that technical functionalities of the apparatus are evident from corresponding technical functionalities of the method, and vice versa.

The term “at least partly automated guidance” encompasses one or several of the following instances: assisted guidance, partly automated guidance, highly automated guidance, fully automated guidance.

“Assisted guidance” means that a driver of the motor vehicle continuously performs either transverse or longitudinal guidance of the motor vehicle. The respective other driving task (i.e., controlling the longitudinal and/or transverse guidance of the motor vehicle) is carried out automatically. This therefore means that in a context of assisted guidance of the motor vehicle, either transverse or longitudinal guidance is controlled automatically.

“Partly automated guidance” means that in a specific situation (for instance, driving on an expressway, driving within a parking facility, passing an object, driving within a lane that is defined by lane markings) and/or for a certain period of time, longitudinal and transverse guidance of the motor vehicle are controlled automatically. A driver of the motor vehicle need not him- or herself manually control the longitudinal and transverse guidance of the motor vehicle. The driver must, however, continuously monitor automatic control of the longitudinal and transverse guidance so as to be able to intervene manually if necessary. The driver must be prepared at any time to completely take over motor vehicle guidance.

“Highly automated guidance” means that for a certain period of time in a specific situation (for instance, driving on an expressway, driving within a parking facility, passing an object, driving within a lane that is defined by lane markings) longitudinal and transverse guidance of the motor vehicle are controlled automatically. A driver of the motor vehicle need not him- or herself manually control the longitudinal and transverse guidance of the motor vehicle. The driver need not continuously monitor automatic control of the longitudinal and transverse guidance so as to be able to intervene manually if necessary. If necessary, a takeover prompt to take over control of the longitudinal and transverse guidance is automatically outputted to the driver, in particular is outputted with a sufficient time margin. The driver must therefore potentially be capable of taking over control of the transverse and longitudinal guidance. Limits of automatic control of transverse and longitudinal guidance are automatically recognized. With highly automated guidance it is not possible to automatically bring about a minimum-risk state in every initial situation.

“Fully automated guidance” means that in a specific situation (for instance, driving on an expressway, driving within a parking facility, passing an object, driving within a lane that is defined by lane markings) longitudinal and transverse guidance of the motor vehicle are controlled automatically. A driver of the motor vehicle need not him- or herself manually control the longitudinal and transverse guidance of the motor vehicle. The driver need not monitor automatic control of the longitudinal and transverse guidance so as to be able to intervene manually if necessary. Before automatic control of transverse and longitudinal guidance ends, a prompt is automatically issued to the driver, in particular with a sufficient time margin, to take over the driving task (controlling transverse and longitudinal guidance of the motor vehicle). If the driver does not take over the driving task, a minimum-risk state is automatically reestablished. Limits of automatic control of transverse and longitudinal guidance are automatically recognized. In all situations, it is possible to automatically reestablish a minimum-risk system state.

In an example embodiment of the present invention, provision is made that the demand encompasses a future demand for required processing resources.

This therefore means, for instance, that a determination is made, for a predetermined period of time in the future, as to what the demand for processing resources will then be.

This can be carried out, for instance, based on predicted parameters.

Provision is made according to an embodiment, for instance, that a required time (demand time) for the determined demand is determined. This therefore means in particular that an indication is given of a required time within which the requested computing performance or required computing performance must be furnished.

In particular, a continuous adaptation of the calculations and of the adaptation takes place.

In an example embodiment of the present invention, a computer-grouping architecture is modified in order to adapt the available processing resources to the determined demand, and/or for adaptation based on the discrepancy.

In an example embodiment of the present invention, provision is made that execution of one or several steps is outsourced to a computer network that is part of a cloud infrastructure.

A technical advantage thereby produced is, for instance, that the steps can be carried out efficiently. In addition, the computer network can thereby be utilized efficiently. A computer of the infrastructure which may be present can also thereby be relieved of those calculations.

Exemplifying embodiments of the present invention are depicted in the figures and are explained in further detail in the description below.

### BRIEF DESCRIPTION OF THE DRAWINGS

FIG. 1 is a flow chart of a method for determining a demand for processing resources for carrying out processing of data for at least partly automated guidance of a motor vehicle, in accordance with an example embodiment of the present invention.

FIG. 2 shows an apparatus, in accordance with an example embodiment of the present invention.

FIG. 3 shows a machine-readable storage medium, in accordance with an example embodiment of the present invention.

FIG. 4 shows a computer system, in accordance with an example embodiment of the present invention.

FIG. 5 shows an infrastructure, in accordance with an example embodiment of the present invention.

FIG. 6 is a flow chart of a further method for determining a demand for processing resources for carrying out processing of data for at least partly automated guidance of a motor vehicle, in accordance with an example embodiment of the present invention.

FIG. 7 shows a portion of the figure in accordance with FIG. 5, in accordance with an example embodiment of the present invention.

FIGS. 8 to 10 each show a computer network, in accordance with an example embodiment of the present invention.

Identical reference characters may be used below for identical features.

### DETAILED DESCRIPTION OF EXAMPLE EMBODIMENTS

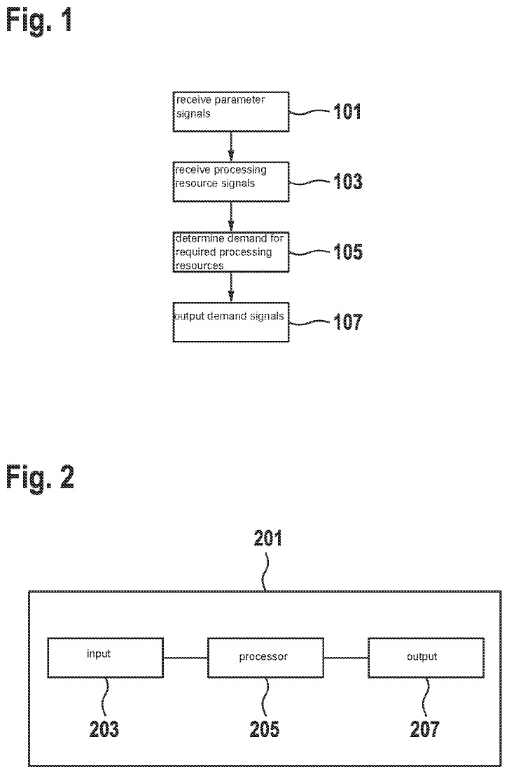

FIG. 1 is a flow chart of a method for determining a demand for processing resources for carrying out processing of data for at least partly automated guidance of a motor vehicle is furnished, encompassing the following steps:
receiving 101 parameter signals that represent at least one parameter influencing processing resources for carrying out processing of data for at least partly automated guidance of a motor vehicle;
receiving 103 processing resource signals that represent available processing resources for carrying out processing of data for at least partly automated guidance of a motor vehicle; determining 105 a demand for required processing resources for carrying out processing of data for at least partly automated guidance of a motor vehicle, based on the at least one parameter and based on the available processing resources;
outputting 107 demand signals, which represent the determined demand and/or a discrepancy between the determined demand and the available processing resources, if the available processing resources for carrying out processing of data for at least partly automated guidance of a motor vehicle are not sufficient to allow the available processing resources to be adapted based on the determined demand and/or on the discrepancy.

In an embodiment of the present invention, provision is made that demand signals are outputted only when the available processing resources for carrying out processing of data for at least partly automated guidance of a motor vehicle are not sufficient. In other words, no demand signals are outputted if the available processing resources for carrying out processing of data for at least partly automated guidance of a motor vehicle are sufficient.

In an embodiment, provision is made that demand signals are outputted even when the available processing resources for carrying out processing of data for at least partly automated guidance of a motor vehicle are sufficient.

FIG. 2 shows an apparatus 201.

Apparatus 201 is configured to execute all steps of the method in accordance with the first aspect.

Apparatus 201 encompasses an input 203 that is configured to receive the parameter signals and the processing-resource signals.

Apparatus 201 further encompasses a processor 205 that is configured to determine the demand for required processing resources.

Apparatus 201 further encompasses an output 207 that is configured to output the demand signals if the available processing resources for carrying out processing of data for at least partly automated guidance of a motor vehicle are not sufficient to allow the available processing resources to be adapted based on the determined demand and/or on the discrepancy.

In an embodiment, provision is made that the demand signals are outputted only if the available processing resources are not sufficient for carrying out processing of data for at least partly automated guidance of a motor vehicle.

This therefore means that if the available processing resources are sufficient for carrying out processing of data for at least partly automated guidance of a motor vehicle, an output of demand signals is omitted.

In an embodiment, provision is made that the demand signals are outputted in all cases. This therefore means in particular that the demand signals are outputted regardless of whether the available processing resources are sufficient or insufficient.

The available processing resources are adapted based on the outputted demand signals, i.e., based in particular on the determined demand and/or on the discrepancy.

In an embodiment, provision is made that the discrepancy is determined, for instance, by way of the processor.

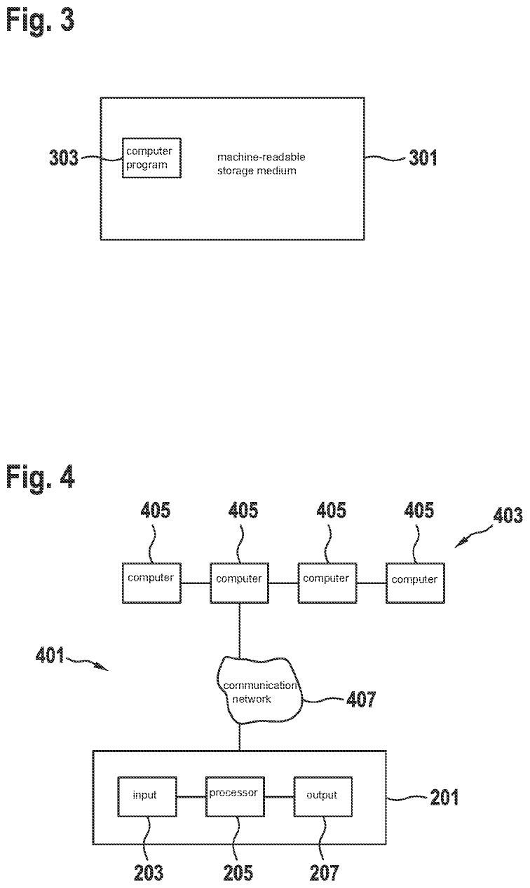

FIG. 3 shows a machine-readable storage medium 301.

A computer program 303 is stored on the machine-readable storage medium 301.

Computer program 303 encompasses instructions that, upon execution of computer program 303 by a computer, cause the latter to execute a method in accordance with the first aspect.

FIG. 4 shows a computer system 401.

Computer system 401 encompasses a computer network 403.

Computer network 403 encompasses several networked computers 405.

Computer system 401 further encompasses apparatus 201 in accordance with FIG. 2.

Apparatus 201 is connected via a communication network 407 to computer network 403.

In an embodiment that is not shown, provision can be made that apparatus 201 is part of computer network 403.

Provision is made, for instance, that one of computers 405 is configured to execute all steps of the method in accordance with the first aspect.

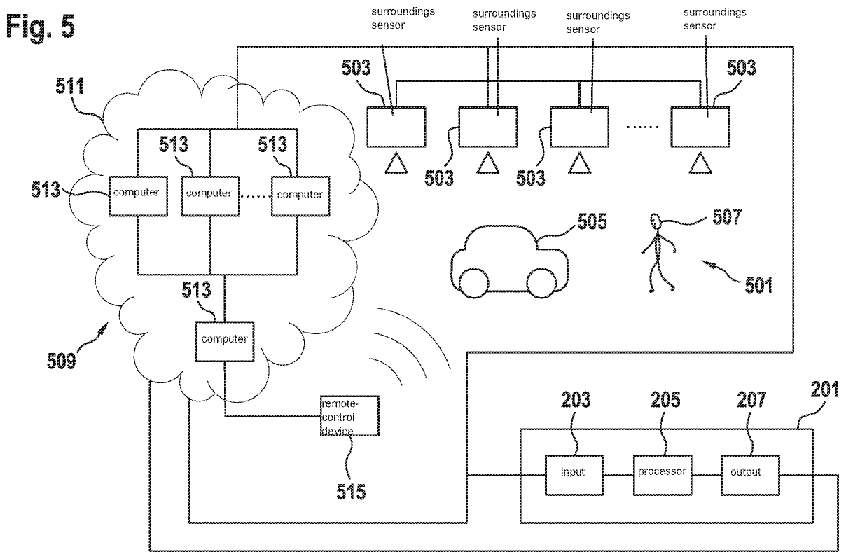

FIG. 5 shows an infrastructure 501.

Infrastructure 501, for instance, is encompassed by a parking facility or is a parking facility.

Infrastructure 501 is monitored by way of several surroundings sensors 503.

Depicted by way of example are a motor vehicle 505 guided in at least partly automated fashion, and a person 507, which are present inside infrastructure 501.

The several surroundings sensors 503 detect their respective surroundings and transmit surroundings data, corresponding to the respective detection, to a computer network 509 that is part of a cloud infrastructure 511.

Computer network 509 encompasses several networked computers 513.

The surroundings data of surroundings sensors 503 are analyzed by way of computers 513 of computer network 509.

Computers 513 can furthermore, for instance, carry out path planning for motor vehicle 505 in order to plan a path that guides motor vehicle 505 around person 507.

The corresponding path plan can then be conveyed to a remote-control device 515, remote-control device 515 being part of infrastructure 501.

Based on the path plan, remote-control device 515 can correspondingly remotely control motor vehicle 505.

This therefore means that provision is made, for instance, that one or several or all data processing steps in the context of processing of data for at least partly automated guidance of a motor vehicle are outsourced to a computer network that is part of a cloud infrastructure.

This therefore means that, for instance, infrastructure 501 itself no longer needs to keep on hand one or several of its own computers that perform those data processing steps.

Provision can of course be made, for instance, that infrastructure 501 itself also encompasses one or several of its own computers, which can carry out processing steps analogously to computer network 509.

Also provided is apparatus 201 in accordance with FIG. 2, which receives from computer network 509 processing-resource signals that represent processing resources which can be made available by way of computer network 509. The processing-resource signals therefore represent available processing resources of computer network 509.

Apparatus 201 is furthermore connected to the several surroundings sensors 503.

For instance, apparatus 201 likewise receives the surroundings data of surroundings sensors 503. Based on those surroundings data, apparatus 201 can determine, for instance, a number of traffic participants within infrastructure 501.

The surroundings data are therefore one of the parameters described above and/or hereinafter.

Provision can furthermore be made, for instance, that surroundings sensors 503 each determine, based respectively on their own surroundings data, a number of traffic participants detected by them, and convey that number to apparatus 201.

For instance, apparatus 201 can then decide whether the available processing resources of computer network 509 are sufficient for carrying out path planning for motor vehicle 505 in a sufficiently short time, despite a possibly large number of further or other traffic participants.

If the processing resources available here are then not sufficient, the apparatus requests more processing resources from computer network 509 by outputting corresponding demand signals to it.

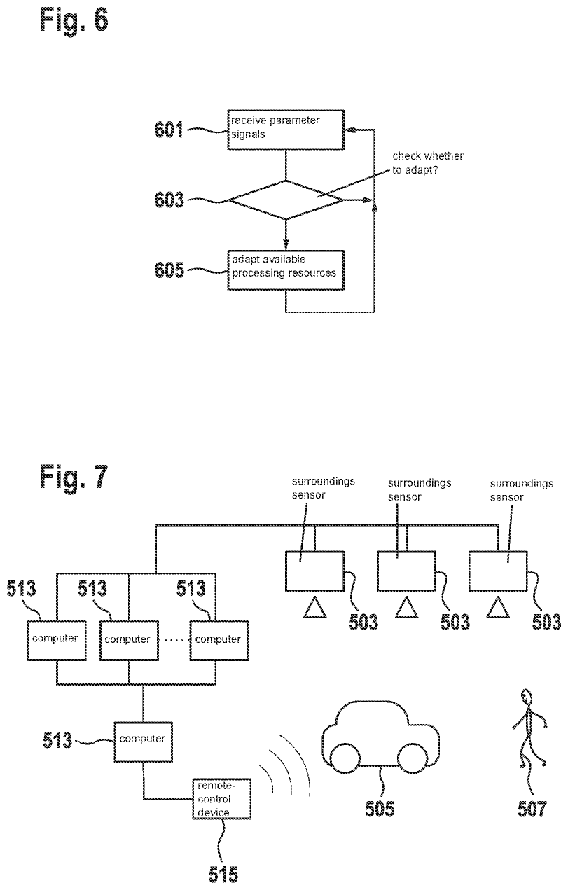

FIG. 6 is a flow chart of a further method for determining a demand for processing resources for carrying out processing of data for at least partly automated guidance of a motor vehicle.

In a step 601, as described above and/or hereinafter, parameter signals and processing-resource signals are received.

Step 601 further encompasses a determination of the demand for required processing resources, based on the parameters and on the available processing resources.

A step 603 checks whether the available processing resources must or should be adapted.

This therefore means that if the determined demand is less than, or less than or equal to, the available processing resources, a decision is made in step 603 that no adaptation of the available processing resources needs to be carried out or, in an embodiment that is not shown, that the available processing resources are to be adapted, i.e., decreased, so as advantageously to economize on or efficiently utilize processing resources.

The method then begins again with step 601.

If the determined demand is greater than the available processing resources, however, a decision is made that the available processing resources must be adapted.

Provision is then made for adaptation of the available processing resources in a step 605.

The method then continues in step 601.

This therefore means that the concept described here provides for calculation of a necessary computing performance (demand for required processing resources).

Provision is made, for instance, that the demand encompasses a future demand for required processing resources.

This therefore means, for instance, that for a predetermined period of time in the future, a determination is made as to what the demand for processing resources will then be.

This can be carried out, for instance, based on the predicted parameters.

Provision is made according to an embodiment, for instance, that a required time (demand time) is determined for the determined demand. This therefore means in particular that a required time, within which the requested computing performance or the required computing performance must be furnished, is indicated.

In particular, a continuous adaptation of the calculations and of the adaptation takes place.

FIG. 7 shows a portion of the drawing in accordance with FIG. 5.

Be it noted at this juncture that the number of computers 513 of computer network 509 can be variable.

This therefore means that whereas only three computers 513 are shown in FIG. 5 and FIG. 7, more or fewer than three computers can be provided in embodiments that are not shown.

The number of computers of a computer network can be varied or adapted based on the determined demand and/or based on the discrepancy.

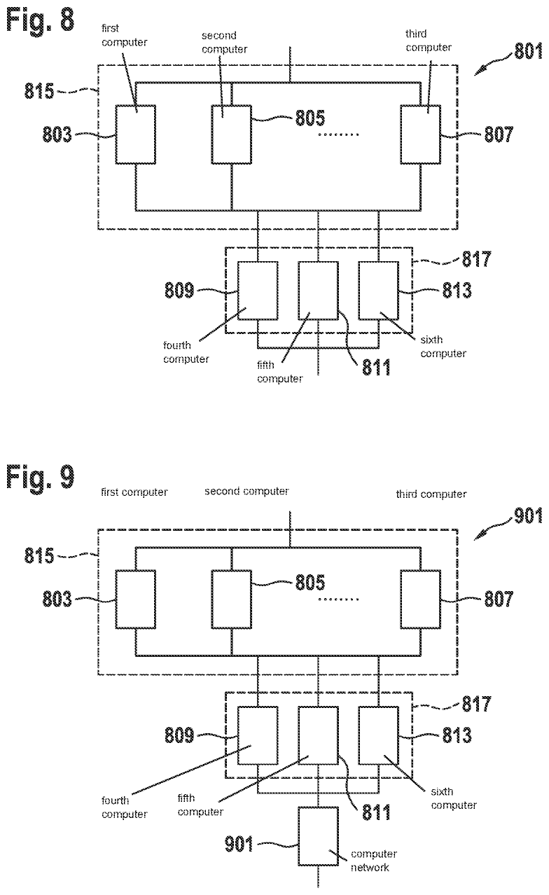

FIG. 8 shows a computer network 801.

Computer network 801 encompasses a first computer 803, a second computer 805, and a third computer 807.

These three computers constitute a first assemblage 815 of computers which process data for a predetermined function that is to be performed for at least partly automated guidance of a motor vehicle.

These three computers, for example, perform an analysis or evaluation of surroundings data.

Computer network 801 further encompasses a fourth computer 809, a fifth computer 811, and a sixth computer 813, which constitute a second assemblage 817 of several computers.

The computers of second assemblage 817, for example, process data for a further predetermined function that is to be performed for at least partly automated guidance of a motor vehicle.

For example, the computers of second assemblage 817 handle path planning for a motor vehicle guided in at least partly automated fashion, that path planning being carried out, for example, based on the evaluation or analysis of the computers of first assemblage 815.

A number of computers of first assemblage 815 and of second assemblage 817 can vary here as well, in particular depending on the determined demand or on the discrepancy.

FIG. 9 shows a further computer network 901.

Computer network 901 is constituted in part identically to computer network 801 in accordance with FIG. 8.

Computer network 901 additionally encompasses a seventh computer 901 that, for instance, carries out processing of data for yet another predetermined function.

This therefore means that within a computer network in accordance with the concept described here, different computers can process data for different predetermined functions.

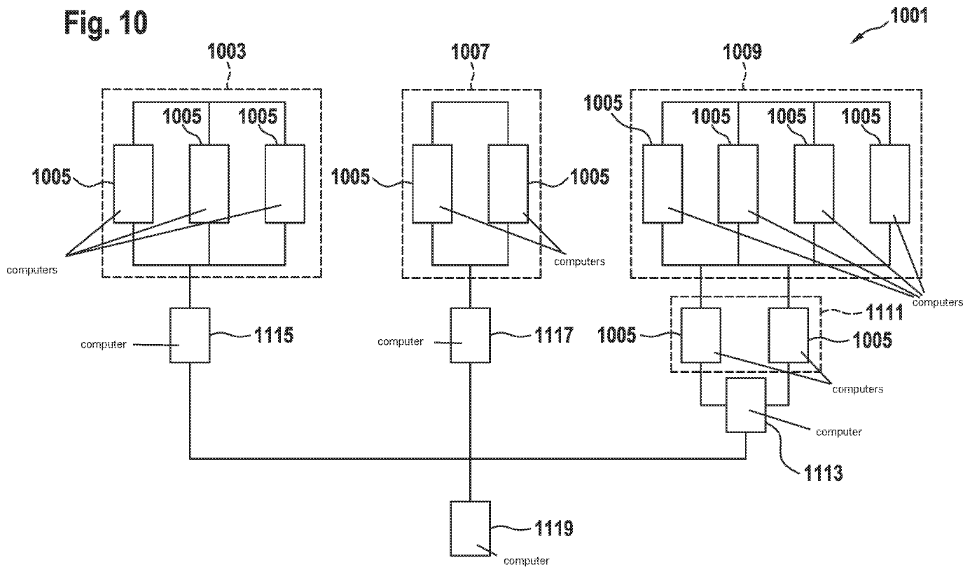

FIG. 10 shows a further computer network 1001.

Computer network 1001 encompasses a first assemblage 1003 of three computers 1005 that process data for a first predetermined function.

Computer network 1001 encompasses a second assemblage 1007 of two computers 1005 that process data for a second predetermined function.

Computer network 1001 encompasses a third assemblage 1009 made up of four computers 1005 that process data for a third predetermined function.

Computer network 1001 furthermore encompasses further computers 1113, 1115, 1117, and 1119 that can process data for at least partly automated guidance of a motor vehicle.

A determination as to whether available processing resources must be adapted is made, for instance, based on a computation time that represents a time required by the computers to carry out the calculations and/or partial calculations. For instance, if the computation time is above a predetermined computation time threshold value, the number of computers is, for instance, increased.

A determination as to whether available processing resources must be adapted is carried out, for example, based on reliability requirements for the computers. Reliability requirements encompass, for instance, an indication of the maximum permitted duration of an outage time of a computer.

The calculations for scalability (i.e., as to whether or not adaptation must occur) can be carried out in the computer network itself and/or in an external system and/or, in order to ensure performance/functionality, in several systems, for instance several computer networks.

In general, the algorithm or the function is predefined on the computers. In other words, the procedure is not to modify the algorithm or function, but to request or acquire the computer performance required for it (but, in particular, no more) so that, in particular, costs and simultaneously performance can be optimized based on an adaptation to current boundary conditions.

The above-described assemblages made up of several computers can, for instance, each perform a predetermined function, in particular in parallel.

In accordance with an embodiment, provision is furthermore made that the determination of the demand is made based on one or several parameters.

One such parameter describes, for instance, current reliability requirements with respect to “safety” (current reliability requirement with respect to safe at least partly automated guidance of a motor vehicle). Current reliability requirements encompass or are, for instance: number of redundant calculations; scope of the results of redundant calculations (for example, consideration is given to the question of how different results are to be handled; with different results, for instance, additional calculations must be carried out, for example calculations must be repeated); safe distances between motor vehicles as specifications, which can have an influence on the required computing performance.

One such parameter describes, for instance, current reliability requirements with respect to “security” (current reliability requirement with respect to secure processing of surroundings data), e.g., hacking security, new defense mechanisms, etc.

The reliability requirements described above have an influence in particular on the demand for processing resources, so that a determination of the demand can be made efficiently in consideration of one or several of the reliability requirements.

For instance, if more redundant calculations (i.e., processing steps utilizing the data) need to be carried out, the demand, for instance, increases.

1-11. (canceled)

12. A method for determining a demand for processing resources for carrying out processing of data for at least partly automated guidance of a motor vehicle, comprising the following steps:
receiving parameter signals that represent at least one parameter influencing processing resources for carrying out processing of data for at least partly automated guidance of a motor vehicle;
receiving processing resource signals that represent available processing resources for carrying out processing of data for the at least partly automated guidance of the motor vehicle;
determining a demand for required processing resources for carrying out the processing of data for the at least partly automated guidance of the motor vehicle, based on the at least one parameter and based on the available processing resources; and
outputting demand signals, which represent the determined demand and/or a discrepancy between the determined demand and the available processing resources, when the available processing resources for carrying out the processing of data for the at least partly automated guidance of the motor vehicle are not sufficient to allow the available processing resources to be adapted, based on the determined demand and/or on the discrepancy.

13. The method as recited in claim 12, wherein the at least one parameter is a respective element selected from the following group of parameters: (i) size of an infrastructure within which motor vehicles are being and/or are to be at least partly automatedly guided; (ii) number of motor vehicles currently being at least partly automatedly guided within the infrastructure; (iii) number of other traffic participants, other than at least partly automatedly guided motor vehicles, which are currently present within the infrastructure; (iv) environmental parameters of the infrastructure including weather data, and/or light data, and/or visibility data, and/or motor-vehicle-internal processing resources, and/or infrastructure-internal processing resources, and/or performance parameters of a surroundings sensor of the infrastructure; (v) processing resources of a computer and/or of a computer network; (vi) current reliability requirement with regard to reliable at least partly automated guidance of a motor vehicle; (vii) current reliability requirement with regard to reliable processing of the data, a current reliability requirement indicating a number of redundant processing steps utilizing the data.

14. The method as recited in claim 12, wherein the determination of the demand includes a determination of a demand time that indicates how long the determined demand will be required, the demand signals additionally representing the determined demand time.

15. The method as recited in claim 12, wherein the determination of the demand includes a determination of a functional demand for processing resources for a predetermined function that is to be performed for the at least partly automated guidance of the motor vehicle, the demand signals additionally representing the determined functional demand.

16. The method as recited in claim 12, wherein in reaction to the outputting of the demand signals, the available processing resources are adapted based on the determined demand and/or on the discrepancy.

17. The method as recited in claim 12, wherein the data includes one or several elements of the following group of data: (i) sensor data of a surroundings sensor; (ii) weather data; (iii) navigation data; (iv) position data; (v) control data for controlling transverse and/or longitudinal guidance of the motor vehicle; (vi) traffic data; (vii) result data of a result of a calculation for the at least partly automated guidance of the motor vehicle; (viii) diagnostic data of a sensor of the motor vehicle.

18. The method as recited in claim 12, wherein one or more of the steps of the method is outsourced to a computer network that is part of a cloud infrastructure.

19. An apparatus configured to determine a demand for processing resources for carrying out processing of data for at least partly automated guidance of a motor vehicle, the apparatus configured to:
receive parameter signals that represent at least one parameter influencing processing resources for carrying out processing of data for at least partly automated guidance of a motor vehicle;
receive processing resource signals that represent available processing resources for carrying out processing of data for the at least partly automated guidance of the motor vehicle;
determine a demand for required processing resources for carrying out the processing of data for the at least partly automated guidance of the motor vehicle, based on the at least one parameter and based on the available processing resources; and
output demand signals, which represent the determined demand and/or a discrepancy between the determined demand and the available processing resources, when the available processing resources for carrying out the processing of data for the at least partly automated guidance of the motor vehicle are not sufficient to allow the available processing resources to be adapted, based on the determined demand and/or on the discrepancy.

20. A computer system, comprising:
a computer network that has several networked computers is part of a cloud infrastructure; and
an apparatus configured to determine a demand for processing resources for carrying out processing of data for at least partly automated guidance of a motor vehicle, the apparatus configured to:
receive parameter signals that represent at least one parameter influencing processing resources for carrying out processing of data for at least partly automated guidance of a motor vehicle,
receive processing resource signals that represent available processing resources for carrying out processing of data for the at least partly automated guidance of the motor vehicle,
determine a demand for required processing resources for carrying out the processing of data for the at least partly automated guidance of the motor vehicle, based on the at least one parameter and based on the available processing resources, and
output demand signals, which represent the determined demand and/or a discrepancy between the determined demand and the available processing resources, when the available processing resources for carrying out the processing of data for the at least partly automated guidance of the motor vehicle are not sufficient to allow the available processing resources to be adapted, based on the determined demand and/or on the discrepancy.

21. A non-transitory machine-readable storage medium on which is stored a computer program for determining a demand for processing resources for carrying out processing of data for at least partly automated guidance of a motor vehicle, the computer program, when executed by a computer, causing the computer to perform the following steps:
receiving parameter signals that represent at least one parameter influencing processing resources for carrying out processing of data for at least partly automated guidance of a motor vehicle;
receiving processing resource signals that represent available processing resources for carrying out processing of data for the at least partly automated guidance of the motor vehicle;
determining a demand for required processing resources for carrying out the processing of data for the at least partly automated guidance of the motor vehicle, based on the at least one parameter and based on the available processing resources; and
outputting demand signals, which represent the determined demand and/or a discrepancy between the determined demand and the available processing resources, when the available processing resources for carrying out the processing of data for the at least partly automated guidance of the motor vehicle are not sufficient to allow the available processing resources to be adapted, based on the determined demand and/or on the discrepancy.
